(19) United States
(12) Patent Application Publication
(10) Pub. No.: US 2003/0093697 A1
(43) Pub. Date: May 15, 2003

(54) Method for preventing unauthorized persons from entering and using a computer facility

(76) Inventor: Wen Chi Lin, Chong Ho City (TW)

Correspondence Address: Wen Chi Lin, P.O. Box 10-69, Chong Ho, Taipei Hsien, 235, TW

(21) Appl. No.: 09/986,821

(22) Filed: Nov. 13, 2001

(51) Int. Cl. H04L 9/32

(52) U.S. Cl. 713/202; 382/124; 340/5.82

(57) ABSTRACT

A method for preventing unauthorized persons from entering and using a computer facility includes storing the fingerprints of authorized persons in a control center or in a processor unit, detecting and comparing a fingerprint of a detected person to enter into the computer facility with the stored fingerprints to determine whether the detected fingerprint matches the stored fingerprints or not. The person is permitted to enter into the computer facility when the fingerprint matches with the stored fingerprints and/or the passwords matches with the stored passwords.

### BACKGROUND OF THE INVENTION

1. Field of the Invention

The present invention relates to a method, and more particularly to a method for preventing unauthorized persons from entering and using a computer facility.

2. Description of the Prior Art

Typical computer systems or facilities or the like may provide a verification system or an identification system for identifying the users and for allowing only the authorized persons or users to enter into the computer systems or facilities or the like, and for preventing the other unauthorized persons or the hackers from entering into the computer systems or facilities or the like. Mostly, the verification system or the identification system adopt the password to identify and to check the users. However, the password may be too long to remember, such that the users may usually forget the password. In addition, the password is required to be changed frequently for preventing the computer systems or facilities or the like from being entered by the other unauthorized persons or the hackers, such that the users may further usually and may have a good chance to forget the password.

The present invention has arisen to mitigate and/or obviate the afore-described disadvantages of the conventional verification systems or identification systems for computer systems or facilities or the like.

### SUMMARY OF THE INVENTION

The primary objective of the present invention is to provide a method for preventing unauthorized persons from entering and using a computer facility.

The other objective of the present invention is to provide a method for providing a double security system to the sensitive or dangerous computer systems or facilities or the like.

The further objective of the present invention is to provide a method for providing a method for identifying the authorized persons with password and/or fingerprint.

The still further objective of the present invention is to provide a method for allowing the users to enter into computer systems or facilities or the like, in some circumstances, without the password when they forgot the password.

In accordance with one aspect of the invention, there is provided a method for preventing unauthorized persons from entering and using a computer facility, the method comprising, storing first fingerprints of authorized persons, detecting a second fingerprint of a detected person to enter into the computer facility, comparing the second fingerprint with the first fingerprints to determine whether the detected second fingerprint matches the stored first fingerprints or not, and permitting the detected person to enter into the computer facility when the second fingerprint matches with the stored first fingerprints.

A processor unit and a fingerprint image sensor are further provided and coupled to the processor unit for detecting the second fingerprint and for entering the second fingerprint into the processor unit.

An input/output device is further provided and coupled to the processor unit for entering passwords into the processor unit.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan schematic view illustrating the facilities required for a method in accordance with the present invention, for preventing unauthorized persons from entering and using a computer facility; and

FIG. 2 is a block diagram illustrating the reasoning of the method in accordance with the present invention.

### DETAILED DESCRIPTION OF THE PREFERRED EMBODIMENT

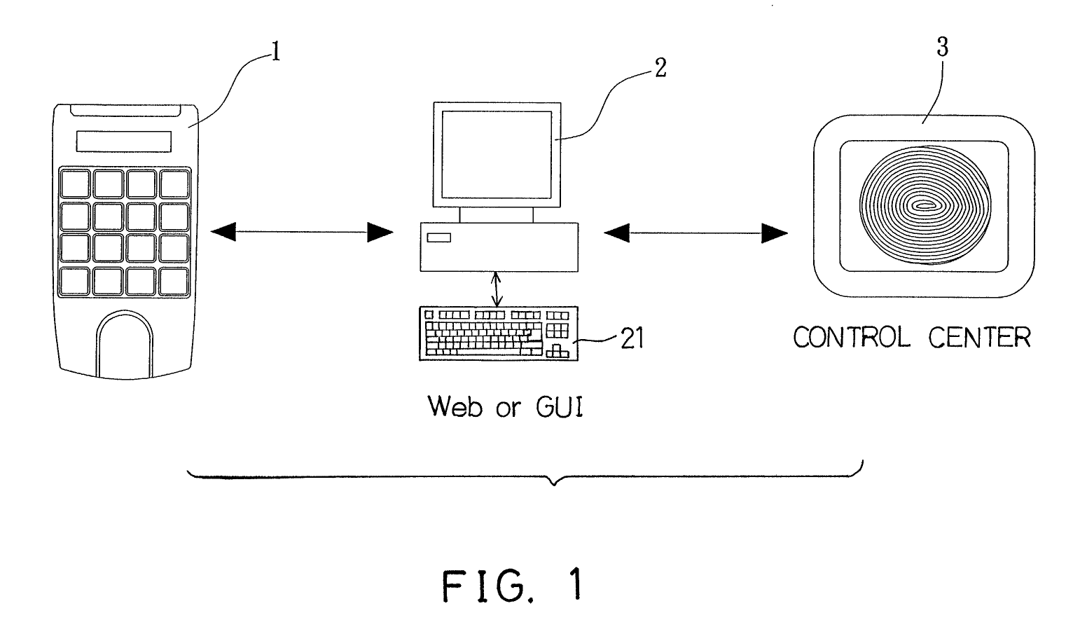

Referring to the drawings, and initially to FIG. 1, the facilities requied for a method in accordance with the present invention comprise a monitor, a computer, a personal computer or a processor unit 2 or the like, for entering into a web site, a graphical user interface (GUI), a net work, or the like. A fingerprint image sensor 1 is coupled to the processor unit 2 for sensing or detecting the fingerprint of the users and for sending the fingerprint images of the users into the processor unit 2. The stored fingerprint images of various kinds of persons or the authorized persons may be directly stored in the processor unit 2, or may be stored in a data base, or a control center 3 or the like. For example, the control center 3 may be coupled to the processor unit 2 for sending the stored fingerprint images to the processor unit 2 and for comparing with the fingerprint images detected by the fingerprint image sensor 1, and for verifying or for identifying whether the person is the authorized person or the unauthorized person.

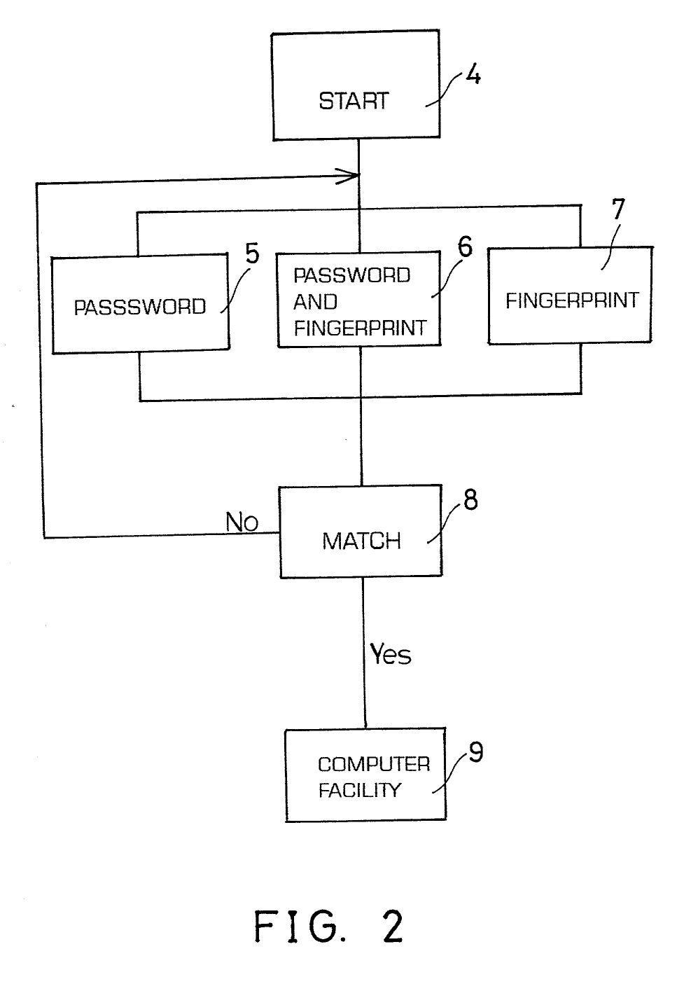

Referring next to FIG. 2, the person who would like to enter into the computer facility 9 or the like may start 4 with the processor unit 2 as shown in FIG. 1. The processor unit 2 or the control center 3 may ask the person to enter either or both the password and the fingerprint at 5, 6, or 7. For example, the computer facilities that have lower security level may only require the password at 5 or the fingerprint at 7. The computer facilities that have higher or greater security level may require both the password and the fingerprint at 6. The requirement may be shown at the monitor or at the processor unit 2 by the control center 3 or the like. An input/output device, such as a keyboard 21 may be coupled to the processor unit 2, for entering the password into the processor unit 2.

The processor unit 2 may then compare the password and/or the fingerprint entered from the fingerprint image sensor 1 with the password and/or the fingerprint stored in the data base of the control center 3, for example, and may determine whether the entered password and/or the fingerprint is matched with the stored passwords and/or the fingerprints or not at 8. If the entered password and/or the fingerprint is matched with the stored password and/or the fingerprint, the person may then be allowed to enter into the computer facility 9. If not matched, the person may then be rejected to enter into the computer facility and may be required or asked to enter the password and/or the fingerprint once again.

In operation, the authorized persons may enter or are permitted to enter into the computer facility 9 with either the password or the fingerprint, or with both the password and the fingerprint, according to or depending on the security levers required for entering into the computer facilities.

Accordingly, the verification system or the identification system in accordance with the present invention may use either or both the password and the fingerprint for providing a double security system to the sensitive or dangerous computer systems or facilities or the like, or for allowing the users to enter into computer systems or facilities or the like without the password when they forgot the password.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for preventing unauthorized persons from entering and using a computer facility, said method comprising:
storing first fingerprints of authorized persons;
detecting a second fingerprint of a detected person to enter into the computer facility;
comparing said second fingerprint with said first fingerprints to determine whether the detected second fingerprint matches said stored first fingerprints or not, and
permitting said detected person to enter into the computer facility when said second fingerprint matches with said stored first fingerprints.

2. The method according to claim 1 further comprising providing a processor unit and a fingerprint image sensor, coupling said fingerprint image sensor to said processor unit for detecting said second fingerprint and for entering said second fingerprint into said processor unit.

3. The method according to claim 2 further comprising providing and coupling an input/output device to said processor unit for entering passwords into said processor unit.

4. A method for preventing unauthorized persons from entering and using a computer facility, said method comprising:
providing a processor unit and a fingerprint image sensor;
storing a first password in said processor unit;
coupling said fingerprint image sensor to said processor unit;
storing first fingerprints of authorized persons in said processor unit;
detecting a second fingerprint of a detected person to enter into the computer facility with said finger print image sensor;
entering said second fingerprint into said processor unit;
comparing said second fingerprint with said first fingerprints to determine whether the detected fingerprint matches the stored fingerprints or not;
providing and coupling an input/output device to said processor unit for entering a second password into said processor unit, and
permitting said detected person to enter into the computer facility either when said second fingerprint matches with said stored first fingerprints or when said second password matches with said first password.

5. A method for preventing unauthorized persons from entering and using a computer facility, said method comprising:
providing a processor unit and a fingerprint image sensor;
storing a first password in said processor unit;
coupling said fingerprint image sensor to said processor unit;
storing first fingerprints of authorized persons in said processor unit;
detecting a second fingerprint of a detected person to enter into the computer facility with said finger print image sensor;
entering said second fingerprint into said processor unit;
comparing said second fingerprint with said first fingerprints to determine whether the detected fingerprint matches the stored fingerprints or not;
providing and coupling an input/output device to said processor unit for entering a second password into said processor unit, and
permitting said detected person to enter into the computer facility when said second fingerprint matches with said stored first fingerprints and when said second password matches with said first password.
